(19) United States
(12) Patent Application Publication
(10) Pub. No.: US 2008/0015711 A1
(43) Pub. Date: Jan. 17, 2008

(54) SYSTEMS AND METHODS FOR FOREST HARVEST MANAGEMENT

(76) Inventors: Normand Charland, Richmond (CA); Jeannette Charland, Richmond (CA); Etienne Charland, Richmond (CA)

Correspondence Address: BERESKIN AND PARR, 40 KING STREET WEST, BOX 401, TORONTO, ON, M5H 3Y2, US

(21) Appl. No.: 11/426,684

(22) Filed: Jun. 27, 2006

(51) Int. Cl. G05B 15/00; B27M 1/00; B27M 3/00

(52) U.S. Cl. 700/1; 144/329

(57) ABSTRACT

In accordance with aspects of the present invention, provided are systems, methods and computer program products for: creating an inventory of un-harvested logs; simulating the growth of the un-harvested log inventory; estimating current and projected values of the un-harvested log inventory; and, providing a consolidated price-schedule listing normalized, and thus, comparable purchase price information from multiple buyers.

The section headings used herein are for organizational purposes only and are not to be construed as limiting the claims in any way.

### FIELD OF THE INVENTION

The invention relates to tools for forest management, including systems and methods for forest growth simulation, and for forest harvest management.

### BACKGROUND OF THE INVENTION

The Forest Industry can be subdivided into forest material suppliers and forest material processors. The forest material suppliers include, for example and without limitation, loggers, private woodlot owners, and sometimes government departments representing public forests designated for commercial forestry. The forest material processors include, for example and without limitation, pulp and paper operations, sawmills, fibre board, veneer, pellets . . . etc.. The forest material suppliers harvest logs to supply the forest material processors that in turn convert the logs into vendible products, such as lumber, veneer, fibre board, pellets and paper.

Large-scale operators, such as those found in the Pulp and Paper Industry, often employ a full range of personnel organized into the operational units needed to harvest, transport and process forest products. By contrast, smaller-scale operators typically focus on one of logging, transport and processing (e.g. milling). In turn a number of smaller-scale operators work in concert to harvest, transport and process forest products, each buying and/or selling from the other as trees are harvested as logs and transported to mills for processing into vendible products.

The vendible products sold by the mills (i.e. the forest material processors) are not sold in accordance with the same valuation-metric used to purchase the logs from the loggers (i.e. the forest material suppliers). For example, mills sell lumber in quantities measured in Board-Feet (BFT) or cubic-meters (m³), whereas mills purchase logs based on a combination of species, grade, size. The selling prices for milled lumber (and other vendible products) are typically much higher than normalized purchasing prices for the raw logs. The presumptions that justify the different valuation-metrics include: not all of a raw log is usable wood; a significant portion of usable wood in raw logs is wasted in the milling process; the mills have significant operational overhead including energy costs; and, the mills add value by processing raw logs into vendible products.

Additionally, different mills, as compared to one another, often offer different buying prices for the same species, grade and size of logs. That is, there is often a difference between purchase prices offered by different mills for the same species, grade and size of logs. For example, a particular mill may need a particular species, grade and size of logs to satisfy a large order for lumber of the particular species, grade and size. In turn, that particular mill may be willing to purchase the particular species, grade and size at a premium as compared to other mills.

However, the price-schedule formats used often differ between mills and each price-schedule may specify the prices in terms of board-feet or cubic-meters (or another metric used for finished vendible products) with reference to a specific table, and there are around 100 different tables used for this purpose. Price comparison between buyers is thus difficult. These factors make it difficult to ascertain the current best available market prices for specified logs, which in turn make it difficult for loggers to sort logs and select mills so that the logs can be sold at the best available market prices. Accordingly, a logger may find that a selected mill heavily discounts the value of a particular truckload of logs, once the logs arrive at the mill and are appraised. In such an instance, the logger may have little choice but to accept the discounted price or try to select a new mill using similar unclear price-schedules and incurring additional transport costs for moving the logs to the newly selected mill.

The task of managing a woodlot involves deciding what sections of the woodlot to harvest and when, in addition to deciding on harvesting techniques, such as clear cut or selective cut. For private woodlot owners, this task has been done for the most part by “eye ball” assessment of the woodlot, an intuitive sense of growth rates and market value of logs. Simulation systems, that can more accurately predict biomass growth than an individual's estimation based on experience, are rarely used.

### SUMMARY OF THE INVENTION

According to an aspect of an embodiment of the invention there is provided a method of simulating forest growth in which generating log classification data related to said forest is used to determine growth of logs in said forest. In some embodiments, this is achieved by defining growth parameters for a portion of a forest, assessing a sample area of the portion of the forest to determine a classification of logs on trees in said sample area to provide a representative estimate of log classification data for the portion of the forest, simulating changes, such as size and number of logs of each grade available for harvest at a future time, in the portion of the forest using said growth parameters and log classification data, and providing a result of said simulated changes in the portion of the forest. In some embodiments, the result includes a monetary value of a quantity of logs available for harvest, and/or a quantity of logs for each species, grade, size available for harvest. When the forest includes varied divisions, some embodiment involve also surveying a portion of a forest to define a plurality of divisions, and assessing a respective sample area for each division to provide a corresponding estimate of log classification data in each division. A respective sample area may be assessed for each division to corresponding information included in the growth parameters for each division.

In some embodiments, log classification data includes at least one of tree grade, size, species, a number of trees of each species and a number of trees infected with diseases.

The growth parameters can be simply a rate of growth, such as an annual growth rate, that can be roughly estimated and/or based on analysis of growth rings of existing trees from recent years. Alternatively, the growth parameters can be used to determine a growth rate, and in this case can include a number of trees infected with diseases, soil characteristics, ground water depth, historic weather data, projected weather patterns and pollution measurements.

In some embodiments, a pruning operation to be implemented within said forest is defined, and a value of the forest or a harvest with said pruning operation and without said pruning operation is determined. A comparison report based on the determining can be generated.

In some embodiments, there is provided a method of determining the value of a forest harvest having log classification data, in which buyer purchase price information is obtained from a plurality of buyers, said purchase price information including purchase price of logs of at least some species in terms of linear length of cut lumber in accordance with different tables for at least some buyers, and a value of said harvest is calculated for each of said buyers using said log classification data and said buyer purchase price information. A maximized monetary value, on a per transport load basis, for the harvest can be thus determined. Likewise, a transport load cost can be determined for each buyer for a given location of said forest harvest, and said maximized monetary value can discount transport load cost. The buyer purchase price information may include for example buying prices based on grade, size and species for each buyer.

In other embodiments, the invention provides a method of providing a consolidated log purchase price report by obtaining buyer purchase price information from a plurality of buyers, said purchase price information including purchase price of logs of at least some species in terms of linear length of cut lumber in accordance with different tables for at least some buyers, and consolidating the buyer purchase price information by converting all of the buyer purchase price information into a standard format sorted by species, grade and size, and generating a report containing a comparison of purchase price in said standard format for at least one species and according to grade and size. Obtaining buyer purchase price information may be repeated frequently to have current buyer purchase information.

In some embodiments, a database associated with a server is built for the purposes of consolidating the buyer purchase price information, and said generating comprises users communicating with the server from remote terminals over a data network and selecting one or more species and two or more of all said buyers for the purposes of generating said report. Generating the report can involve printing said report on paper and placing it in a protective transparent cover for use in assessing in the field the composition and destination of loads of cut trees.

While the present invention can be implemented as a process or method, it will be understood that the invention relates equally to the corresponding apparatus, networked computer systems and/or computer program products.

Other aspects and features of the present invention will become apparent, to those ordinarily skilled in the art, upon review of the following description of the specific embodiments of the invention.

### BRIEF DESCRIPTION OF THE DRAWINGS

For a better understanding of the present invention, and to show more clearly how it may be carried into effect, reference will now be made, by way of example, to the accompanying drawings, which illustrate aspects of embodiments of the present invention and in which:

FIG. 1A is a schematic drawing of a system in accordance with aspects of the invention;

FIG. 1B is a schematic drawing of a modified version of the system of FIG. 1A in accordance with aspects of the invention;

FIG. 2 is a flow chart illustrating the general steps of a method for simulating changes in an inventory of un-harvested logs in accordance with aspects of the invention;

FIG. 3A is a flow chart illustrating the general steps of a first method of estimating the value of un-harvested logs in accordance with aspects of the invention;

FIG. 3B is a flow chart illustrating the general steps of a second method of estimating the value of un-harvests logs in accordance with aspects of the invention;

FIG. 4 is a flow chart illustrating the general steps of a method of providing a consolidated purchase price-schedule in accordance with aspects of the invention;

FIG. 5 is a schematic drawing of a tree that has been conceptually divided into a number of un-harvested logs in accordance with aspects of the invention;

FIG. 6A is an end view of a first log;

FIG. 6B is an end view of a second log;

FIG. 6C is an end view of a third log;

FIG. 6D is an end view of a fourth log; and

FIG. 7 illustrates the value of a maple forest over time comparing the effect of pruning versus absence of pruning.

### DETAILED DESCRIPTION OF THE INVENTION

In relationships between loggers and various mills, the loggers are often disadvantaged. The disadvantages are caused by: unclear purchase price-schedules provided in varying and non-standardized formats, which often do not provide a valuation-metric for raw logs; a lack of consolidated and comparable purchase price information from different mills available to the loggers; and, log transportation costs that are primarily, if not fully, absorbed by the loggers. These disadvantages sometimes result in unfair discounted valuations of logs harvested by loggers. Moreover, once a logger selects and ships logs to a chosen mill, the logger is often forced into accepting the purchase price offered by the mill. If instead, the logger is unwilling to accept a purchase price offered, the logger also must be willing to absorb additional transport costs to ship the logs to a newly selected mill.

By contrast, in accordance with aspects of the present invention, provided are systems, methods and computer program products for: creating an inventory of un-harvested logs; simulating the growth of the un-harvested log inventory; estimating current and projected values of the un-harvested log inventory; and, providing a consolidated price-schedule listing normalized, and thus, comparable purchase price information from multiple buyers. That is, some aspects of the invention may help provide consolidated purchase price information for loggers. Such information may be used to plan harvests, manage portions of forest and select mills with the best offered purchase prices for particular logs, which in turn may lead to higher profits for loggers and less wastage of natural resources. Furthermore, the planning of individual truck loads of logs of particular classifications to particular buyers can be done.

Moreover, some aspects of the invention provide a forest material supplier useful information about the projected output of a portion of a forest, which may lead to changes in forest management decisions relating to the harvesting of forest material. Accordingly, some software embodiments of the invention provide a report and/or plot of log value for a portion of a forest over a projected period corresponding to a suitable valuation window for the species of tree. For example, in a particular scenario it may be advantageous to wait to harvest a certain species of logs so that those logs have a chance to appreciate in value as a result of their projected growth and maturation. As a result the improved information that can be gleaned using aspects of the invention may help loggers become more profitable.

Aspects of the invention may be embodied in a number of forms. For example, various aspects of the invention can be embodied in a suitable combination of hardware, software and firmware. In particular, some embodiments include, without limitation, entirely hardware, entirely software, entirely firmware or some suitable combination of hardware, software and firmware. In a preferred embodiment, the invention is implemented in software, which includes but is not limited to firmware, resident software, microcode, etc.

Additionally and/or alternatively, aspects of the invention can be embodied in the form of a computer program product accessible from a computer-usable or computer-readable medium providing program code for use by or in connection with a computer or any instruction execution system. For the purposes of this description, a computer-usable or computer readable medium can be any apparatus that can contain, store, communicate, propagate, or transport the program for use by or in connection with the instruction execution system, apparatus, or device.

A computer-readable medium can be an electronic, magnetic, optical, electromagnetic, infrared, or semiconductor system (or apparatus or device) or a propagation medium. Examples of a computer-readable medium include a semiconductor and/or solid-state memory, magnetic tape, a removable computer diskette, a random access memory (RAM), a read-only memory (ROM), a rigid magnetic disk and an optical disk. Current examples of optical disks include, without limitation, compact disk-read only memory (CD-ROM), compact disk-read/write (CD-R/A) and DVD.

In accordance with aspects of the invention, a data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output (i.e. I/O devices)—including but not limited to keyboards, displays, pointing devices, etc.—can be coupled to the system either directly or through intervening I/O controllers.

Network adapters may also be coupled to the system to enable communication between multiple data processing systems, remote printers, or storage devices through intervening private or public networks. Modems, cable modems and Ethernet cards are just a few of the currently available types of network adapters.

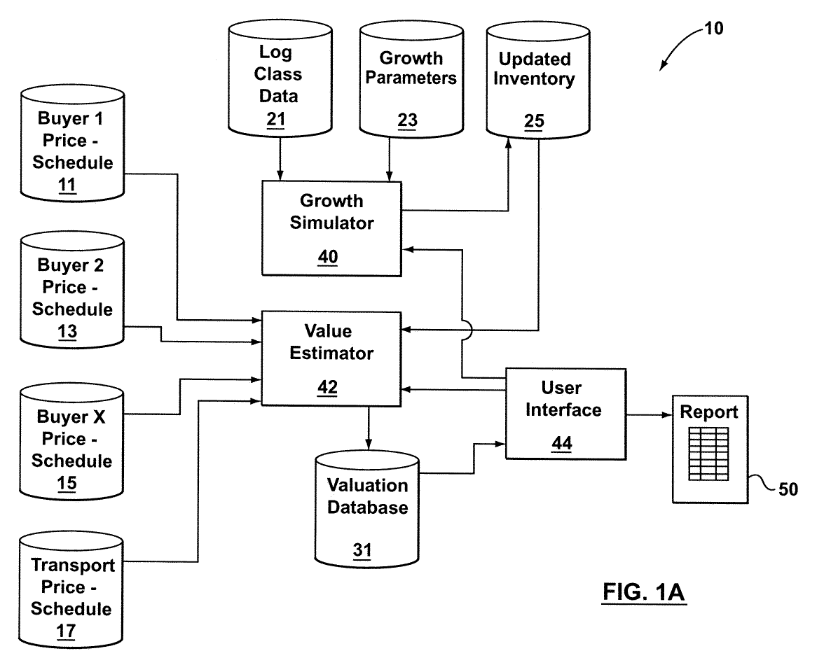

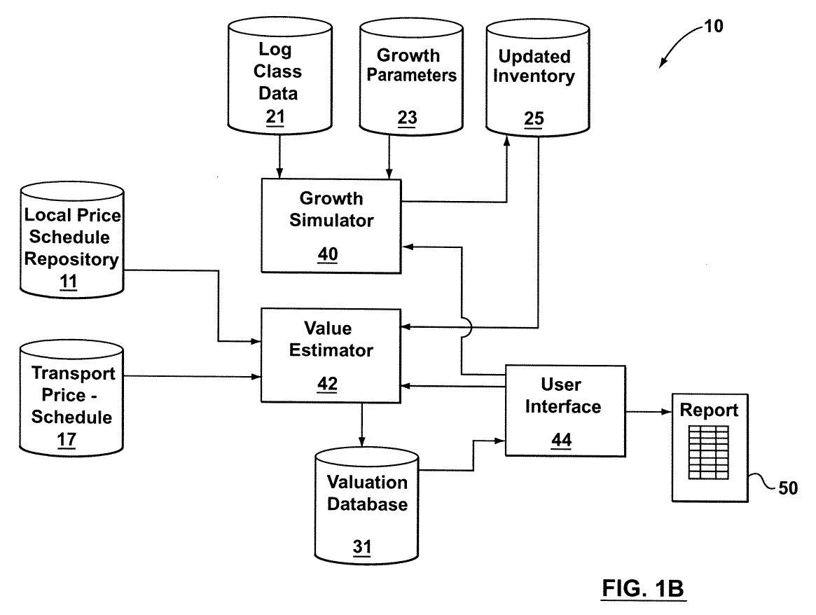

Referring to FIG. 1A, shown is a simplified schematic drawing of a system 10 in accordance with aspects of the invention. Those skilled in the art will appreciate that the system 10 includes a suitable combination of structural elements, mechanical components, hardware, firmware and software arranged to support the function and operation of the system 10, and, for the sake of simplicity, portions of the system 10 have been divided into functional units in order to conveniently describe aspects of this specific embodiment. To that end, the system 10 includes a growth simulator module 40, a value estimator module 42, a user interface module 44 and a number of electronic data repositories that are, in some embodiments, individually and/or in combination organized as relational databases.

The electronic data repositories include a transportation price-schedule 17, log classification data 21, growth parameters 23, an updated inventory listing 25 and a valuation database 31. The electronic data repositories also include buyer (purchase) price-schedules 11, 13 and 15. While only three buyer price-schedules 11, 13 and 15 have been illustrated for the sake of example, those skilled in the art will appreciate that any number of buyer price-schedules can be stored electronically in accordance with aspects of the invention.

Additionally and/or alternatively, the system 10 illustrated in FIG. 1A can be modified so that the buyer (purchase) price-schedules are collectively stored together in a consolidated electronic data repository. Turning to FIG. 1B, shown is a modified system 10′ similar to system 10 shown in FIG. 10, with the exception that the buyer price-schedules 11, 13 and 15 have been replaced with a local price-schedule repository 11′. The remainder of the system 10′ illustrated in FIG. 1B is similar to the remainder system 10 illustrated in FIG. 1, and accordingly, elements common to both share common reference numerals and will not be described again for the sake of brevity.

In accordance with aspects of the invention, the systems 10 and 10′ respectively illustrated in FIGS. 1A and 1B have multiple functions relating to: creating an inventory of un-harvested logs; simulating the growth of the un-harvested log inventory; estimating current and projected values of the un-harvested log inventory; and, providing a consolidated price-schedule listing normalized, and thus, comparable purchase price information from multiple buyers.

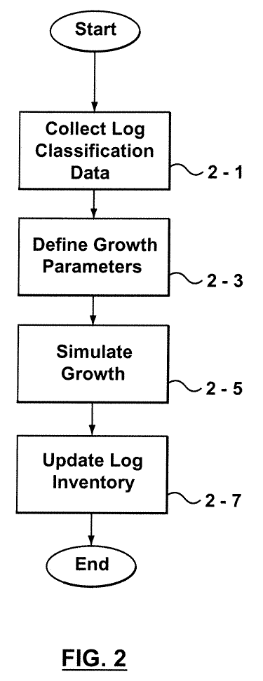

An example of a method for creating and updating an inventory of un-harvested logs is illustrated in the flow chart shown in FIG. 2. In some embodiments creating and updating an inventory includes surveying a portion of a forest to define a plurality of divisions, and assessing a respective sample area for each division to provide a corresponding estimate of log classification data in each division. The sample areas are chosen to be representative of the respective divisions, such that the survey of the sample area can be extrapolated to the entire division with a reasonable estimate of the log classification for the entire division. To this end, starting at step 2-1, the method includes collecting log classification data to establish base data for the log inventory. With added reference FIGS. 1A and 1B, in some embodiments, this step specifically includes storing the log classification data in the log classification data 21 electronic data repository.

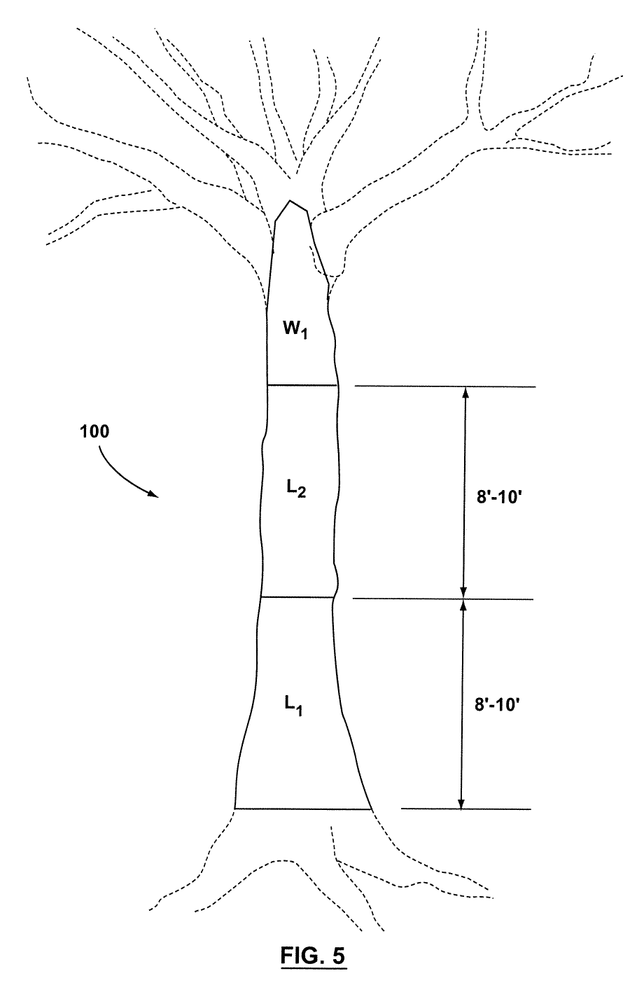

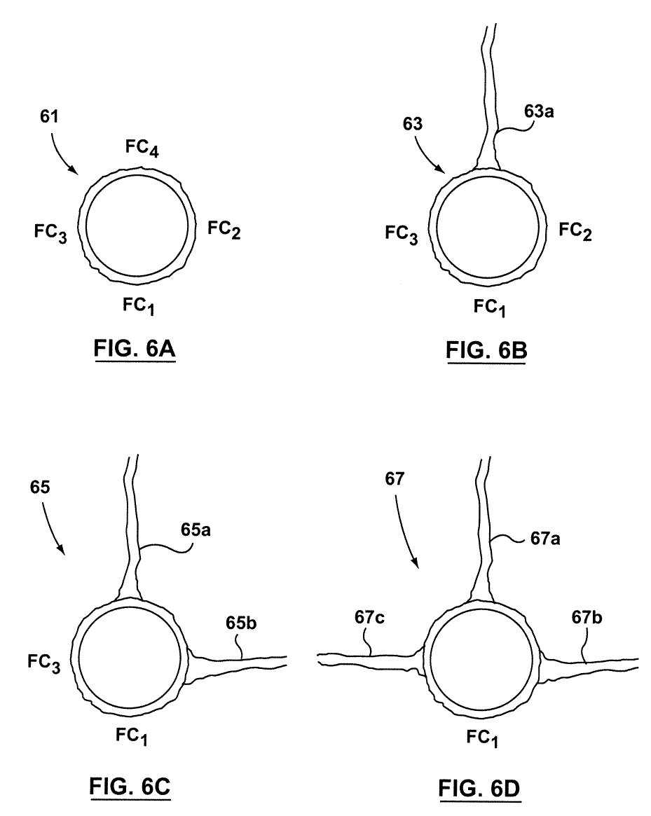

Log classification data includes species, grade and size of each log in each un-harvested tree in a portion of a forest or woodlot. More specifically, with reference to FIGS. 5 and 6A-6D, log classification data includes the number of logs available in a tree and an assessment of the grade of each log based on a visual inspection of the log.

With specific reference to FIG. 5, shown is a schematic representation of a tree 100 that has been conceptually divided into a number of usable logs in accordance with aspects of the invention. Typically, the standard length of a usable log ranges from 8′ to 10′. The tree 100 has two usable logs L₁ and L₂ and one waste portion W₁ that is not long enough to qualify and be sold as a log. As the tree 100 grows the waste portion W₁ may eventually become long enough to qualify as a log. Accordingly, in some embodiments the grade and size of the waste portion W₁ are included in the log classification data.

The grade of an un-harvested log is often only based on a visual inspection of the un-harvested log. Sometimes an evaluation of grade includes, for example and without limitation, the diameter of the un-harvested log, the amount of twist in the log, the amount of bow or curvature of the log, and/or whether or not the un-harvested log has visible scars from broken branches, diseases, etc. One specific classification of grade is a determination of the number of clear faces on an un-harvested log. A clear face is a side without a branch and/or other visible damage or scarring. Although logs are round in shape, the total number of sides or faces used for this determination is four. That is, each log is considered to have four faces.

A classification of a tree in the field can be expected to be a very good classification of the most effective identification of logs that a tree can yield. However, it will be appreciated that the sample survey could collect log classification data that simply identifies the species and the external shape (diameter as a function of height, measure of bow or curvature, twist, etc.) of the whole tree, along with branch location information, and the identification of usable logs from each tree could be done during simulation, either by way of manual entry or automatically. In some cases, there may be different possibilities of usable logs for a tree, for example two 12′ logs or three 8′ logs in a tree that has 24′ greater than a minimum diameter, and when two 12′ logs are worth more than three 8′ logs, the system may suggest identifying the two logs instead of the three for the particular tree. The different possibilities may thus each be assessed for harvest value to select preferred log identification. If a particular log size selection would not be readily apparent to a logger performing the harvest, the system may provide as output the preferred log identification for a particular tree species, size, shape and branch configuration, so that what is harvested actually matches what the system suggested. Furthermore, the trees that are sampled in the forest can be individually monitored over time and compared to the simulated growth. The growth parameters can thus be adjusted to faithfully reflect what is happening in the forest.

In one embodiment, the estimation of the number of logs on a tree (LoT) is simply done by a visual inspection of the tree to determine the number of 9′ logs. Nine feet is a practical choice because this length is suitable for both board lumber and veneer. The width of the tree is measured with accuracy at 5′ (chest height) while the diameter of the logs is estimated in accordance with a model for the species based on the diameter measured. It has been found that such estimates provide a good basis for simulation when averaged over all trees in a forest. Of course, for estimating the best buyer for a load of logs, more precise knowledge of the log dimensions and other characteristics is important.

With specific reference to FIGS. 6A-6D, shown are end views of four different logs 61, 63, 65 and 67, respectively. Referring first to FIG. 6A, the log 61 has four clear faces indicated by FC₁, FC₂, FC₃ and FC₄. The log 63, shown in FIG. 6B, has three clear faces FC₁, FC₂ and FC₃ and a branch 63a on the fourth face. The log 65, shown in FIG. 6C, has two clear faces FC₁ and FC₃ and branches 65a and 65b on the other two faces. Lastly, the log 67, shown in FIG. 6D, has only one clear face FC₁ and branches 67a, 67b and 67c on the other three faces. Generally, a log with a higher number of clear faces is considered to be of a higher grade.

Referring back to FIG. 2, at step 2-3 the method includes defining growth parameters for the logs in the inventory. In some embodiments, the growth parameters are simply the annual rate of growth for species. A rough estimate is acceptable, and the estimate can be adjusted if in a few years, the prediction of growth does not match what is happening in the forest for sample trees. To get this estimate initially, trees can be cored or simply cut down to measure growth rings. This gives a good short history of growth rates for species. The height at which the growth rings are measured is at about 5 feet. It is of course possible to estimate the rate of growth using other parameters that can be measured. Trees cut to estimate growth can also be used as sample trees for determining the composition of the forest. The total length of the logs of a tree is from the bottom cut to a point where, in the case of hardwoods, the tree diameter is only 3″. For softwoods, this diameter may be greater. In some embodiments, the simulated growth of the logs is in width only. However, the simulation may add a log to a tree when it can be projected that the diameter of the tree reaches 3″ (or other value for the top of the trunk of the species) at 9′ from the top of the last 9′ log on the tree when the survey was done (in the case that logs are 9′ in length). For example, in some embodiments, the growth parameters include a number of trees infected with diseases, soil characteristics, ground water depth, historic weather data, projected weather patterns and pollution measurements. With added reference to FIGS. 1A and 1B, in some embodiments this step specifically includes storing the growth parameters in the growth parameters 23 electronic data repository.

At step 2-5 the method includes simulating the growth and/or changes to the logs in the inventory. In some embodiments this may include projecting and/or predicting the presence of new logs on trees in addition to changes in the diameter of each log. In some embodiments, the changes include at least one of size and number of logs of each grade available for harvest at a future time. In some embodiments, the simulated changes are determined at user definable intervals in time ranging from bi-annually to decades. With added reference to FIGS. 1A and 1B, this step may be specifically carried out using the growth simulator module 40. It will be appreciated that the simulation only simulates growth, whereas the actual forest grows annually. By comparing annual growth with the simulation, the simulation parameters can be adjusted to better match actual growth and thus provide a better prediction. In such embodiments, the growth simulator module employs data stored in both the log classification data 21 and the growth parameters 23 electronic data repository.

As a tree grows, the logs on the tree can change their characteristics regarding the number of clear faces. This happens either because branches fall off or move upward with growth. In hardwoods, when a branch naturally falls off or is pruned from a tree, the tree grows to eventually absorb the knot and present a clear face where the branch used to be.

A woodlot owner may stand to gain significant value if hardwoods are pruned at the right time in anticipation of a future harvest. For example, the pruning of two lower branches that will result in the second log being of the category “4 clear faces” instead of “2 clear faces” in 10 years' time could double the value of the log. Clear face logs are easier to transform into veneer, and even into lumber, and as such, their market value is greater. The loss of such branches can be taken into consideration in the simulation of growth as slowing growth, however, lower branches typically receive less light and contributes less to the growth of the tree than the upper branches. Thus pruning does not affect significantly the growth of wood volume. The cost of pruning activity when such lower branches are smaller and within easier reach is quickly offset by the significant increase in future harvest value.

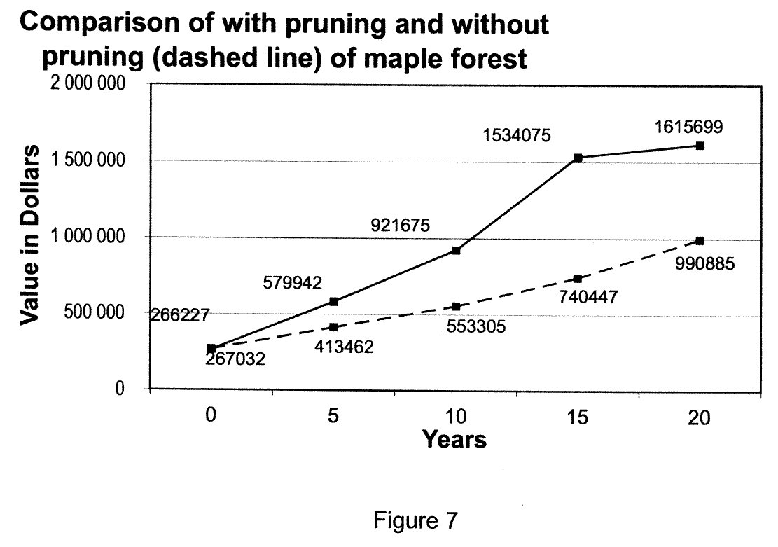

In some embodiments of the invention, a pruning activity is defined as an upgrade of certain logs within the inventory from one class to another. The value of the harvest over time, using expected cost tables for logs according to classification, is then compared for the two cases of with and without the defined pruning activity. This allows a user to see the value of the pruning activity and determine whether such activity is worthwhile. This aspect of the invention is illustrated in FIG. 7 where the upper line shows value of a maple forest with the defined pruning activity performed, and the lower line shows the value without performing the pruning activity. It can also be seen that the impact of the activity is really felt in 15 years where the value at today's prices for maple logs would see the value of the harvest being nearly three times greater (for the same volume of logs). This may suggest an optimal harvest time.

At step 2-7, once the simulation of step 2-5 is complete and or at intervals during the simulation of step 2-5, the method includes updating the log inventory to include projected changes in the logs as the trees grow. With added reference to FIGS. 1A and 1B, in some specific embodiments this step includes updating the updated inventory listing 25.

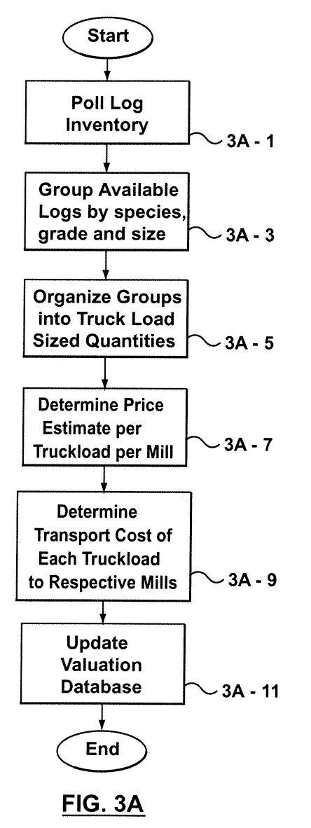

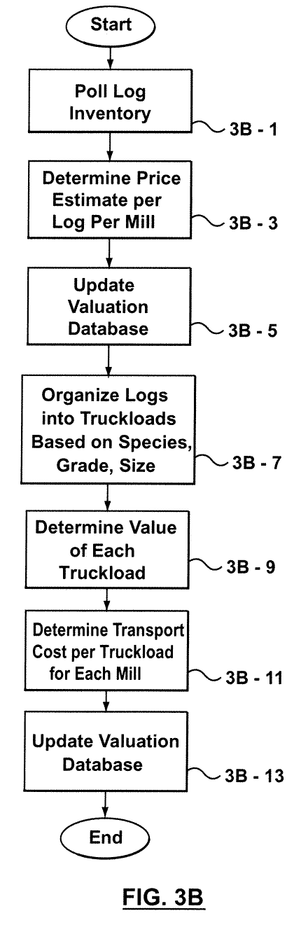

The projected changes in the condition of the logs can then be used to provide estimates of the future value of each un-harvested log in the inventory. To that end, FIGS. 3A and 3B provide respective flow-charts illustrating the general steps of corresponding first and second methods of estimating the value of un-harvested logs in accordance with aspects of the invention.

With reference to FIG. 3A, starting at step 3A-1, the first method includes polling the log inventory to retrieve log classification data for usable (i.e. available logs) presently available and/or available for future harvest. At step 3A-3, the first method includes grouping available logs by species, grade and size. At step 3A-5, the first method includes organizing the groups into truckload-sized quantities. Additionally and/or alternatively, the groups can be organized according to another size metric that is larger or smaller than a truckload. Moreover, given that the size of a truckload is dependent on the size of truck, in some embodiments, the truckload-sized quantity can be defined by the user in terms of, for example and without limitation, at least one of weight, volume and quantity of logs.

At step 3A-7, the first method includes determining the value of each truckload of logs. With added reference to FIGS. 1A and 1B, in some specific embodiments the valuation of a log and/or quantity of logs may occur within the value estimator module 42. In such embodiments, the value estimator module 42 incorporates and uses data stored in the buyer price-schedules 11, 13, 15, the transportation price-schedule, the log classification data and/or the updated inventory listing 25. Additionally and/or alternatively, value estimator module 42 may also factor in costs associated with transporting each truckload of logs to one or more potential buyer, using data stored in the transport price-schedule 17 electronic data repository, so that a logger may know, where the best price for the logs can be obtained, taking into account the cost of shipping. As such, step 3A-9 of the first method includes determining the transportation costs of each truckload to respective mills. Finally, at step 3A-9, the first method includes updating the valuation database 31.

The system output can include the harvest value of the logs of selected woodlot divisions over a number of years (or at a selected time). The value can be based on current pricing of logs offered by mills (and possibly the current transportation costs to each mill). However, in a fluctuating market where prices vary as a function of immediate demand, it is best to use a time average of pricing. The system may use pricing over time that varies in accordance with a model for pricing change, such model would anticipate general inflation, expected changes in log pricing due to supply and demand, and predicted changes in transportation cost. By generating a report of harvest value over time, the system allows the user to determine when is an optimal time to harvest. It can be expected that the value of a division growing at a rate of about 1% of wood mass per year will not grow at the same consistent rate of 1%, even if pricing were constant, since as the trees grow their logs will change classification. This will very likely create within relatively short spans of two to four years more rapid variations in the growth in harvest value, such that value growth may have peaks and valleys. It may be desirable to use such a report to plan a harvest at the end of a peak period of value growth.

FIG. 3B shows a flow chart illustrating the general method steps of a second method similar to the first method described above with respect to FIG. 3A. With reference to FIG. 3B, starting at step 3B-1, the second method includes polling the log inventory to retrieve log classification data for usable (i.e. available logs) presently available and/or available for future harvest. At step 3B-3, the second method includes estimating a number of prices (or values) for each log, where each of the prices is a respective price estimate of the price a particular mill may pay for a particular log. With added reference to FIGS. 1A and 1B, in some specific embodiments the valuation of a log and/or quantity of logs may occur within the value estimator module 42. In such embodiments, the value estimator module 42 incorporates and uses data stored in the buyer price-schedules 11, 13, 15, the transportation price-schedule, the log classification data and/or the updated inventory listing 25. At step 3B-5, the second method includes updating the valuation database 31.

At step 3B-7, the second method includes organizing the groups into truckload-sized quantities based on species, grade and size. Additionally and/or alternatively, the groups can be organized according to another size metric that is larger or smaller than a truckload. Moreover, given that the size of a truckload is dependent on the size of truck, in some embodiments, the truckload-seized quantity can be defined by the user in terms of, for example and without limitation, at least one of weight, volume and quantity of logs. At step 3B-9, the second method includes determining the value of each truckload using the results from step 3B-3 that were stored in the valuation database 31 at 3B-5.

Additionally and/or alternatively, value estimator module 42 may also factor in costs associated with transporting each truckload of logs to one or more potential buyer, using data stored in the transport price-schedule 17 electronic data repository, so that a logger may know, where the best price for the logs can be obtained, taking into account the cost of shipping. As such, step 3B-11 of the second method includes determining the transportation costs of each truckload to respective mills. Finally, at step 3B-11, the first method includes updating the valuation database 31 to include the value of each truckload and cost of shipping each truckload to one or more of the mills.

With reference to FIGS. 1A and 1B, the information stored in the valuation database 31 can be accessed via the user interface module 44 to provide a report 50. In accordance with some aspects of the invention, the report 50 contains a consolidated price-schedule listing normalized, and thus, comparable purchase price information from multiple buyers.

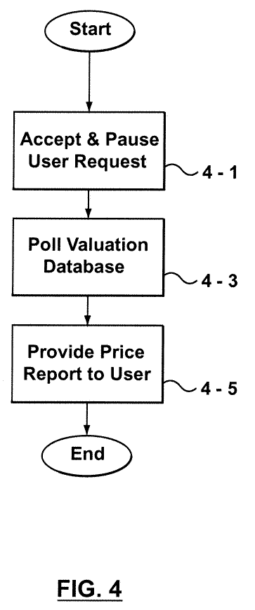

FIG. 4 is a flow chart illustrating the general steps of a method of providing a consolidated purchase price-schedule in accordance with aspects of the invention. With continued reference to FIGS. 1A and 1B, a user uses the user interface module 44 to request a report 50. Accordingly, starting at step 4-1, the method includes accepting and parsing the user request. At step 4-3, the method includes polling the valuation database 31 to retrieve the specific information requested by the user. At step 4-5, the method includes creating the report 50 from the information stored in the valuation database 31.

Thus, the system may be used as a tool that consolidates pricing tables from a variety of mills or buyers into value tables for logs as a function of log classification. Such a table can be prepared without consideration of transport costs, and the user of the table can then estimate such cost before deciding on where to send a load of logs of a particular classification. Alternatively, such a table can be prepared with an estimate of transport costs to each mill or buyer from the woodlot location.

In some embodiments, a web server is implemented to allow users equipped with a web browser system (interface 44) to obtain current tables (report 50) for selected species and classifications that are relevant to the woodlot owner. The user may enter either known distance or travel time for transporting loads from the harvest site to each of the available or selected buyers, in the case that an estimate of transport cost is to be included within the table. A user can use the table in the field to decide on the composition of loads of harvested logs and/or the destination of such loads. When the table is printed on paper, the pages can be placed into a plastic sheet protector (or laminated) to protect them against rain, mud or snow.

The web server can be maintained current as a service, and the users can subscribe to the service, either on a fee basis, and/or the service can be operated from revenue generated by advertising on the web server. Such advertising can also be included in the tables, as for example on the printed sheets that will be consulted in the field.

As an alternative to collecting log pricing information from various buyers and entering it into data files for use by the system including the web server, buyers can be permitted to have an account on the web server to make changes to their pricing as they see fit. In such as case, the buyer will ensure that the pricing entered is current.

While the above description provides example embodiments, it will be appreciated that the present invention is susceptible to modification and change without departing from the fair meaning and scope of the accompanying claims. Accordingly, what has been described is merely illustrative of the application of aspects of embodiments of the invention and numerous modifications and variations of the present invention are possible in light of the above teachings.

We claim:

1. A method of simulating forest growth, the method comprising generating log classification data related to said forest to determine growth of logs in said forest.

2. A method according to claim 1 comprising:
defining growth parameters for a portion of a forest;
assessing a sample area of the portion of the forest to determine a classification of logs on trees in said sample area to provide a representative estimate of log classification data for the portion of the forest;
simulating changes in the portion of the forest using said growth parameters and log classification data; and
providing a result of said simulated changes in the portion of the forest.

3. A method according to claim 2 further comprising:
surveying a portion of a forest to define a plurality of divisions; and
assessing a respective sample area for each division to provide a corresponding estimate of log classification data in each division.

4. A method according to claim 3 further comprising assessing a respective sample area for each division to corresponding information included in the growth parameters for each division.

5. A method according to claim 1, wherein log classification data includes at least one of tree grade, size, species, a number of trees of each species and a number of trees infected with diseases.

6. A method according to claim 2, wherein said growth parameters include a number of trees infected with diseases, soil characteristics, ground water depth, historic weather data, projected weather patterns and pollution measurements.

7. A method according to claim 2, wherein said growth parameters comprise an annual rate of growth for species of trees.

8. A method according to claim 2, wherein the changes include at least one of size and number of logs of each grade available for harvest at a future time.

9. A method according to claim 8, wherein the simulated changes are determined at user definable intervals in time ranging from biannually to decades.

10. A method according to claim 2, wherein the result includes at least one of:
a monetary value of a quantity of logs available for harvest, a quantity of logs for each species, grade, size available for harvest.

11. A method according to claim 1, further comprising estimating a value of said logs to simulate a value of said growth.

12. A method according to claim 11, further comprising:
defining a pruning operation to be implemented within said forest;
determining said value with said pruning operation and without said pruning operation; and
generating a comparison report based on said determining.

13. A method of determining the value of a forest harvest having log classification data, the method comprising:
obtaining buyer purchase price information from a plurality of buyers, said purchase price information including purchase price of logs of at least some species in terms of linear length of cut lumber in accordance with different tables for at least some buyers; and
calculating a value of said harvest for each of said buyers using said log classification data and said buyer purchase price information.

14. A method according to claim 13, wherein said calculating comprises:
determining a maximized monetary value, on a per transport load basis.

15. A method according to claim 14, wherein a transport load cost is determined for each buyer for a given location of said forest harvest, and said maximized monetary value discounts transport load cost.

16. A method according to claim 13, wherein the buyer purchase price information includes buying prices based on grade, size and species for each buyer.

17. A method of providing a consolidated log purchase price report, the method comprising:
obtaining buyer purchase price information from a plurality of buyers, said purchase price information including purchase price of logs of at least some species in terms of linear length of cut lumber in accordance with different tables for at least some buyers; and
consolidating the buyer purchase price information by converting all of the buyer purchase price information into a standard format sorted by species, grade and size; and
generating a report containing a comparison of purchase price in said standard format for at least one species and according to grade and size.

18. A method according to claim 17, wherein said obtaining is repeated frequently to have current buyer purchase information.

19. A method according to claim 18, wherein said consolidating comprises building a database associated with a server, and said generating comprises users communicating with the server from remote terminals over a data network and selecting one or more species and two or more of all said buyers for the purposes of generating said report.

20. A method according to claim 19, wherein said generating comprises printing said report on paper and placing same in a protective transparent cover for use in assessing in the field the composition and destination of loads of cut trees.
